(19) United States
(12) Patent Application Publication
(10) Pub. No.: US 2019/0310136 A1
(43) Pub. Date: Oct. 10, 2019

(54) THERMOMETER AND ASSOCIATED METHOD, APPARATUS AND COMPUTER PROGRAM PRODUCT

(71) Applicant: Nokia Technologies Oy, Espoo (FI)

(72) Inventor: Zhigang Chen, Beijing (CN)

(73) Assignee: Nokia Technologies Oy, Espoo (FI)

(21) Appl. No.: 16/340,191

(22) PCT Filed: Oct. 25, 2016
(86) PCT No.: PCT/CN2016/103174

§ 371 Date: Apr. 8, 2019

(51) Int. Cl. G01J 5/00; G01J 5/08

(52) U.S. Cl. CPC G01J 5/0025; G01J 5/0809

(57) ABSTRACT

A thermometer and associated method, apparatus and computer program product are disclosed for temperature detection. According to an embodiment, the thermometer comprises: a first channel for guiding a first signal for temperature detection of a target; a second channel for guiding a second signal for temperature detection of ambient air; a detection module for using the first and second signals to get a first and second temperature-related parameters respectively; a signal reflector which is able to reflect the first and second signals and movable to a first position such that the first signal is used by the detection module to get the first temperature-related parameter, and a second position such that the second signal is used by the detection module to get the second temperature-related parameter; a drive module for driving the signal reflector to move; and a control module configured to place the signal reflector via the drive module at the first and second positions respectively, and obtain the first and second temperature-related parameters.

### FIELD OF THE INVENTION

Embodiments of the disclosure generally relate to metering technology, and, more particularly, to temperature detection.

### BACKGROUND

Non-contact thermometers such as forehead infrared (IR) thermometer and ear IR thermometer are often used in medical measurement area. They have basically the same working principle. Generally, an IR sensor is used to measure the skin temperature, and another sensor or NTC (negative temperature coefficient) thermistor is used to measure the environment temperature. Then algorithm is used to combine these two values to create a real human inner body temperature (normally is the in-mouth temperature). Compared with conventional contact type thermometers such as mercurial thermometer, non-contact thermometers have the advantages of convenient and fast measurement, no environmental pollution, and the like, and have been increasingly used in recent years. In view of this, it would be advantageous to provide a way to enhance the performance of a non-contact thermometer.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided a thermometer, comprising: a first channel for guiding a first signal for temperature detection of a target; a second channel for guiding a second signal for temperature detection of ambient air; a detection module for using the first and second signals to get a first and second temperature-related parameters respectively; a signal reflector which is able to reflect the first and second signals and movable to a first position such that the first signal is used by the detection module to get the first temperature-related parameter, and a second position such that the second signal is used by the detection module to get the second temperature-related parameter; a drive module for driving the signal reflector to move; and a control module configured to place the signal reflector via the drive module at the first and second positions respectively, and obtain the first and second temperature-related parameters.

According to another aspect of the disclosure, the control module is configured to place the signal reflector at the second and first positions sequentially.

According to another aspect of the disclosure, the control module is further configured to calculate the target's inner temperature based on the first and second temperature-related parameters.

According to another aspect of the disclosure, the second channel is disposed at a different side of the thermometer than the first channel.

According to another aspect of the disclosure, a reflective surface of the signal reflector is a flat surface or a quadratic parabola surface.

According to another aspect of the disclosure, the signal reflector is rotatable to the first position to allow the first signal to reach the detection module along the first channel, and the second position to reflect the second signal to the detection module while blocking the first signal.

According to another aspect of the disclosure, in a case where the signal reflector is placed at the first position, the signal reflector is a portion of the first channel.

According to another aspect of the disclosure, the first channel extends horizontally, the second channel is disposed on a top side of the thermometer, and the drive module is housed in a chamber at the bottom side of the thermometer.

According to another aspect of the disclosure, the signal reflector is rotatable to the first position to reflect the first signal to the detection module while blocking the second signal, and the second position to allow the second signal to reach the detection module along the second channel.

According to another aspect of the disclosure, the signal reflector is rotatable to the first position to reflect the first signal to the detection module, and the second position to reflect the second signal to the detection module.

According to another aspect of the disclosure, the first signal is an infrared radiation from the target, and the second signal is an infrared radiation from the ambient air.

According to another aspect of the disclosure, the second channel comprises a transmissive cover which can allow the second signal to transmit through and is disposed at an end facing the ambient air.

According to another aspect of the disclosure, the second channel further comprises a protective cover openably mounted for protecting the transmissive cover.

According to another aspect of the disclosure, at least one of the first and second channels comprises an emission cover which is made of a material having a high blackbody or laser radiation generation rate, and at least one of the first and second signals is a blackbody or laser radiation from the emission cover.

According to another aspect of the disclosure, the second channel comprises a reflective cover which can reflect an ultrasonic wave, and the second signal is an ultrasonic wave which is emitted from the detection module and reflected back to the detection module via the reflective cover.

According to another aspect of the disclosure, the first signal is an ultrasonic wave which is emitted from the detection module and reflected back to the detection module via the target.

According to another aspect of the disclosure, it is provided a method for temperature detection, comprising: placing a signal reflector via a drive module at a first position such that a first signal which is for temperature detection of a target and guided by a first channel is used by a detection module to get a first temperature-related parameter; obtaining the first temperature-related parameter; placing the signal reflector via the drive module at a second position such that a second signal which is for temperature detection of ambient air and guided by a second channel is used by the detection module to get a second temperature-related parameter; and obtaining the second temperature-related parameter.

According to another aspect of the disclosure, the signal reflector is placed at the second and first positions sequentially.

According to another aspect of the disclosure, the method further comprises: calculating the target's inner temperature based on the first and second temperature-related parameters.

According to another aspect of the disclosure, it is provided an apparatus comprising: at least one processor; and at least one memory including computer-executable code, wherein the at least one memory and the computer-executable code are configured to, with the at least one processor, cause the apparatus to perform steps of any one of the above described methods.

According to another aspect of the disclosure, it is provided an apparatus comprising means configured to perform steps of any one of the above described methods.

According to another aspect of the disclosure, it is provided a computer program product comprising at least one non-transitory computer-readable storage medium having computer-executable program code stored therein, the computer-executable code being configured to, when being executed, cause an apparatus to operate according to any one of the above described methods.

These and other objects, features and advantages of the disclosure will become apparent from the following detailed description of illustrative embodiments thereof, which are to be read in connection with the accompanying drawings.

### BRIEF DESCRIPTION OF THE DRAWINGS

FIG. 1 is a schematic block diagram of a thermometer according to the principle of the present disclosure;

FIGS. 2A and 2B are perspective views showing a thermometer in different operational states according to the first embodiment of the present disclosure;

FIGS. 3A and 3B are partial enlarged views showing a second channel of the thermometer according to the first embodiment of the present disclosure;

FIG. 4 is a partial enlarged view for explaining the working principle of an signal reflector of the thermometer according to the first embodiment of the present disclosure;

FIGS. 5A and 5B are partial enlarged views for explaining the working principle of a drive module of the thermometer according to the first embodiment of the present disclosure;

FIGS. 6A and 6B are schematic diagrams showing a thermometer in different operational states according to the second embodiment of the present disclosure;

FIGS. 7A and 7B are schematic diagrams showing a thermometer in different operational states according to the third embodiment of the present disclosure;

FIGS. 8A and 8B are schematic diagrams showing a thermometer in different operational states according to the fourth embodiment of the present disclosure;

FIG. 9 is a schematic diagram showing a thermometer according to the fifth embodiment of the present disclosure;

FIG. 10 is a schematic diagram showing a thermometer according to the sixth embodiment of the present disclosure;

FIG. 11 depicts a flowchart of a method for temperature detection according to the principle of the present disclosure; and

FIG. 12 is a simplified block diagram showing an apparatus that is suitable for use in practicing some embodiments of the present disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

As mentioned above, environment temperature (or ambient temperature, or room temperature) generally has to be measured for non-contact thermometers such as forehead IR thermometer and ear IR thermometer. However, how to measure it in an easy and precise way is a big problem. This is mainly because of two reasons. Firstly, room temperature should be measured in real-time, preferably just at the same time when the skin temperature is measured. Secondly, the cost for measuring room temperature should be low and should not impact the measurement of the main skin IR sensor.

At present, there are two main solutions for measuring room temperature. One solution is to measure room temperature by a NTC thermistor. This is very poor in real-time performance, because room temperature changes fast and the physical characteristics of a NTC thermistor make it hard to catch this fast change. The other solution is to use a very high cost IR sensor which can measure the long distance skin temperature (around 40 mm) and can also measure the near distance temperature (10-20 mm). This adds a lot of cost, and also results in that the measured room temperature has very big tolerance because it is too close to skin and is prone to be impacted by human body.

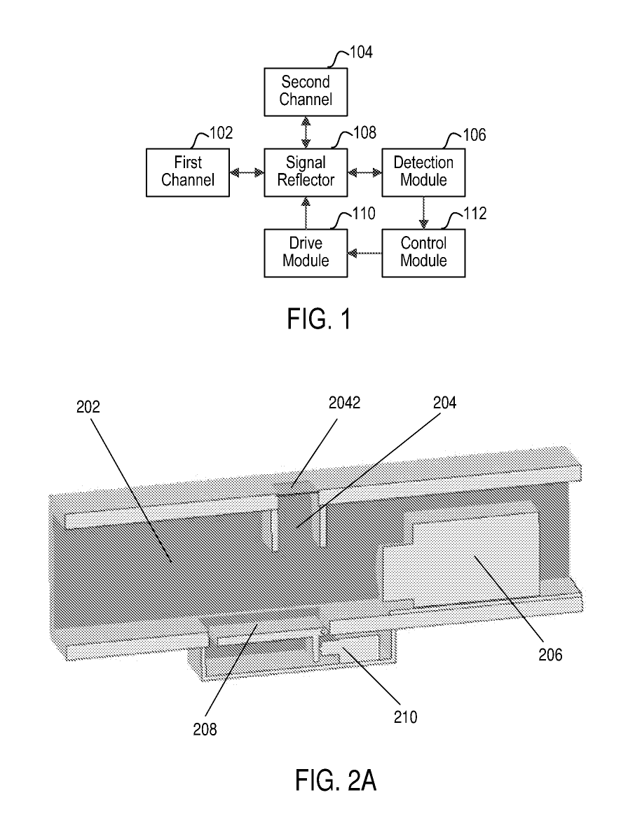

The present disclosure proposes a thermometer which can achieve a better real-time performance in the measurement of room temperature with a low cost. Hereinafter, the thermometer will be described in detail with reference to FIGS. 1-12.

FIG. 1 is a schematic block diagram of a thermometer according to the principle of the present disclosure. As shown in FIG. 1, the thermometer comprises a first channel 102, a second channel 104, a detection module 106, a signal reflector 108, a drive module 110 and a control module 112.

The first channel 102 is provided for guiding a first signal for temperature detection of a target. The target may be any target to which the working principle of the thermometer according to the present disclosure may be applied, that is, any target whose surface temperature is different from inner (or core) temperature and may be influenced by ambient temperature, and thus both the surface temperature and ambient temperature needs to be measured to calculate the inner temperature. For example, the target may include a living body such as a human body, an animal and a plant, and non-living things such as a boiler.

The first signal is related to temperature detection of the target, and may take the form of a wave such as electromagnetic wave (e.g., IR radiation, black body radiation, laser radiation, and the like) and mechanical wave (e.g., ultrasonic wave). In the case of IR radiation, black body radiation and laser radiation, the structure of the thermometer according to the present disclosure may be applied to passive temperature detection process where no dedicated signal generation unit is provided for generating a signal for detection purpose, and may also be applied to active temperature detection process where a dedicated signal generation unit is provided for generating a signal for detection purpose. In the case of ultrasonic wave, the structure of the thermometer according to the present disclosure may be applied to active temperature detection process.

For example, the first channel 102 may be defined by a housing of the thermometer, or may be formed individually within the housing. The contour along the extending direction of the first channel 102 and the cross-section perpendicular to the extending direction are not particularly limited, as long as the first signal can be guided into the interior of the housing when the first channel 102 faces the target. As an example, the first channel 102 may be implemented similar to the shooting head of any existing IR body thermometer.

The second channel 104 is provided for guiding a second signal for temperature detection of ambient air. The second signal is related to temperature detection of ambient air, and may take the form of a wave such as electromagnetic wave (e.g., IR radiation, black body radiation, laser radiation, and the like) and mechanical wave (e.g., ultrasonic wave). As mentioned above, in the case of IR radiation, black body radiation and laser radiation, the structure of the thermometer according to the present disclosure may be applied to passive temperature detection process, and may also be applied to active temperature detection process. In the case of ultrasonic wave, the structure of the thermometer according to the present disclosure may be applied to active temperature detection process.

The second channel 104 may be disposed at a different side of the housing of the thermometer than the first channel to avoid the influence from the target. Similarly to the first channel 102, the second channel 104 may be defined by the housing of the thermometer, or may be formed individually within the housing. The contour along the extending direction of the second channel 104 and the cross-section perpendicular to the extending direction are not particularly limited, as long as the second signal can be guided into the interior of the housing.

In the case of IR radiation, the second channel 104 may optionally comprise a transmissive cover which can allow the second signal to transmit through and is disposed at an end facing the ambient air. In this way, the second signal from the ambient air can pass through the transmissive cover to the interior of the housing. Furthermore, the second channel 104 may optionally comprise a protective cover which is openably mounted on top of the transmissive cover for protecting the transmissive cover. The protective cover may be made of for example a material non-transmissive to the second signal, and may be implemented similarly to a door of a refrigerator. When no measurement is required to be performed, the protective cover may be in a closed state to achieve protection and dust proof functions. When any measurement is required to be performed, the protective cover may be in an opened state to allow the second signal from the ambient air to reach and pass through the transmissive cover to the interior of the housing. At this time, the transmissive cover can play a dust proof function.

In the case of blackbody radiation or laser radiation, the second channel 104 may comprise an emission cover which is made of a material having a high blackbody or laser radiation generation rate and is disposed at an end facing the ambient air. Similarly, the first channel 104 may comprise an emission cover which is made of a material having a high blackbody or laser radiation generation rate and is disposed at an end facing the target.

In the case of ultrasonic wave, the second channel 104 may comprise a reflective cover which can reflect an ultrasonic wave and is disposed at an end facing the ambient air, and the second signal is an ultrasonic wave which is emitted from the detection module 106 (described later) and reflected back to the detection module 106 via the reflective cover.

The detection module 106 is provided for using the first and second signals to get a first and second temperature-related parameters respectively. For example, in the case of IR radiation, the detection module 106 may be an IR sensor for measuring IR radiation. The measured value of IR radiation (i.e., the temperature-related parameter) may indicate the temperature of corresponding entity emitting the IR radiation. Any existing sensors capable of measuring IR radiation may be used as the detection module 106.

In the case of blackbody radiation or laser radiation, the detection module 106 may be a blackbody or laser radiation sensor. The measured value of blackbody or laser radiation (i.e., the temperature-related parameter) may indicate the temperature of corresponding entity emitting the blackbody or laser radiation.

In the case of ultrasonic wave, the detection module 106 may comprise for example an ultrasonic generator for generating a ultrasonic wave (i.e., the second signal), an ultrasonic detector for detecting the ultrasonic wave which is emitted from the ultrasonic generator and reflected back to the ultrasonic detector via the reflective cover, and a timer for measuring the travelling period from the time point at which the ultrasonic wave is generated by the ultrasonic generator to the time point at which the ultrasonic wave is detected by the ultrasonic detector. Since the speed at which an ultrasonic wave travels in the air varies according to the temperature of the air, the speed which equals to the length of the travelling paths of the ultrasonic wave during the travelling period divided by the travelling period may indicate the temperature of the air. Thus, the measured travelling period may be the temperature-related parameter for the ambient air.

Similarly, the ultrasonic generator may generate another ultrasonic wave (i.e., the first signal), the ultrasonic detector may detect the another ultrasonic wave which is emitted from the ultrasonic generator and reflected back to the ultrasonic detector via the target, and the timer may measure another travelling period from the time point at which the another ultrasonic wave is generated by the ultrasonic generator to the time point at which the another ultrasonic wave is detected by the ultrasonic detector. The measured another travelling period may be the temperature-related parameter for the target.

The signal reflector 108 is able to reflect the first and second signals and movable to a first position such that the first signal is used by the detection module 106 to get the first temperature-related parameter, and a second position such that the second signal is used by the detection module 106 to get the second temperature-related parameter. The signal reflector 108 may have at least one reflective surface made of any material capable of reflecting the first and second signals. The reflective surface may be for example a flat surface or a quadratic parabola surface. In the case of the quadratic parabola surface, a better reflection performance can be achieved. In the case of IR radiation, as one example, the signal reflector 108 may be a polished metal plate. As another example, the signal reflector 108 may be a polished glass plate with a coating layer capable of reflecting IR radiation.

Regarding the arrangement of the signal reflector 108, as one example, the signal reflector 108 is rotatable to the first position to allow the first signal to reach the detection module 106 along the first channel 102, and the second position to reflect the second signal to the detection module 106 while blocking the first signal. As another example, the signal reflector 108 is rotatable to the first position to reflect the first signal to the detection module 106 while blocking the second signal, and the second position to allow the second signal to reach the detection module 106 along the second channel 104. As a further example, the signal reflector 108 is rotatable to the first position to reflect the first signal to the detection module 106, and the second position to reflect the second signal to the detection module 106. That is, at least one of the first and second signals is reflected by the signal reflector to the detection module. In the above examples, the signal reflector 108 is not limited to be rotatable, as long as it can be switched between the first and second positions. The details of the arrangement will be described hereinafter in detail with reference to the figures.

The drive module 110 is provided for driving the signal reflector 108 to move. As one example, the drive module 110 may comprise a drive force generating unit such as a motor or an ejector mechanism (e.g., an actuating mechanism using shape memory alloy) for generating a drive force, and a drive force transmission unit such as a gear set for transmitting the drive force to the signal reflector 108. As another example, the drive module 110 may comprise only a drive force generating unit such as a linear motor for providing a drive force directly to the signal reflector 108.

The control module 112 is configured to place the signal reflector 108 via the drive module 110 at the first and second positions respectively, and obtain the first and second temperature-related parameters. For example, the control module 112 may send to the drive module 110 a control signal for driving the signal reflector 108 to a corresponding position. Then, the control module 112 may obtain a corresponding temperature-related parameter from the detection module 106 via wired communication (e.g., a signal transmission line) or wireless communication (e.g., WiFi, Bluetooth, and the like). Optionally, the control module 112 may send a detection command to the detection module 110 to start the detection and then send a retrieval command to retrieve the detected temperature-related parameter. Alternatively, the detection module 110 may perform the detection and send the detected temperature-related parameter to the control module 112 at respective predetermined timings.

Optionally, the control module 112 may be configured to place the signal reflector 108 at the second and first positions sequentially. However, it is also possible that the control module 112 is configured to place the signal reflector 108 at the first and second positions sequentially. Furthermore, the control module 112 may be configured to calculate the target's inner temperature based on the first and second temperature-related parameters. Any existing algorithm may be used for this purpose.

The control module 112 may be implemented as: (a) hardware-only circuit such as implemented as only analog and/or digital circuit; (b) combinations of circuits and software (and/or firmware), such as a combination of digital signal processor(s), software, and memory(ies) that work together to cause various functions to be performed.

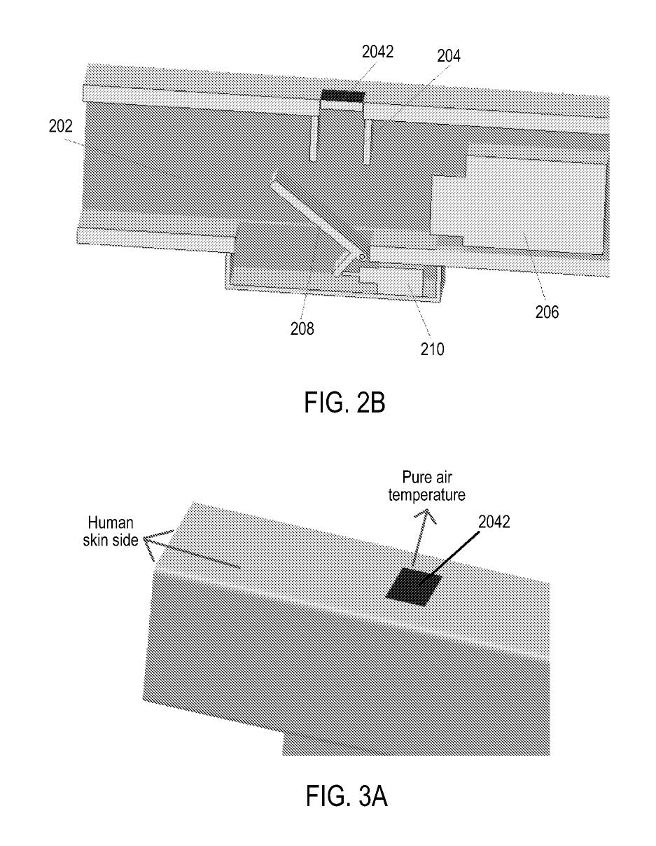

Hereinafter, the thermometer according to the present disclosure will be described with reference to FIGS. 2-8 by taking an IR body thermometer as an exemplary example. That is, the first and second signals are IR radiations, the target is a human body, and the signal reflector is an IR reflector. However, as mentioned above, the present disclosure is not limited to an IR body thermometer.

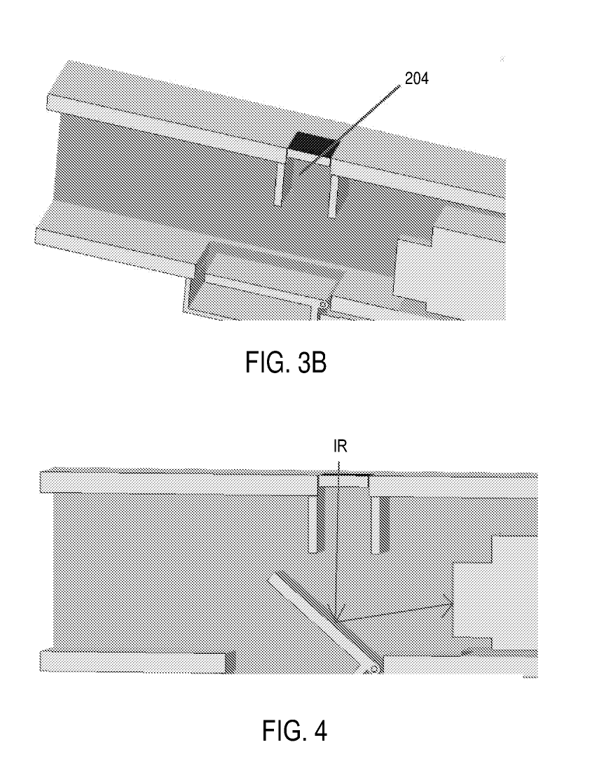

FIGS. 2A and 2B are perspective views showing a thermometer in different operational states according to the first embodiment of the present disclosure. As shown in FIGS. 2A and 2B, the first channel 202 is a hollow cuboid-shaped channel which is mainly defined by the housing of the thermometer. The second channel 204 is a hollow cuboid-shaped channel which is defined by an opening formed on the top housing, two parallel plates (e.g., metal plates) extending downwards from the opening to the interior of the housing, the front housing and the back housing. Since the second channel 204 is disposed at the top housing and the first channel 202 extends from left to right, pure air temperature can be detected by avoiding the influence from the human skin side (see also FIGS. 3A and 3B). The second channel 204 comprises an IR-transmissive cover (e.g., glass cover) 2042 which is disposed to cover the opening. The detection module (e.g., an IR sensor) 206 is disposed at the right side of the second channel 204 to face the first channel 202.

The IR reflector 208 is an L-shaped plate pivotally disposed below the second channel 204. In the operational state of FIG. 2A, the longer side of the L-shaped plate is disposed to extend horizontally, thereby constituting a portion of the first channel 202. Furthermore, the upper surface of the longer side is the IR reflective surface. In this operational state, the first IR radiation from a human body reaches the detection module 206 along the first channel 202, while the second IR radiation from ambient air is reflected upwards by the reflective surface and thus cannot reach the detection module 206. As a result, the detection module 206 only measures the first IR radiation.

In the operational state of FIG. 2B, due to the drive force applied by the drive module 210, the IR reflector 208 is rotated upwards by certain degrees (e.g., about 45 degrees in FIG. 2B) to be inclined downwards from left to right. In this operational state, the second IR radiation from the ambient air is reflected by the reflective surface to the detection module 206 (see also FIG. 4), while the first IR radiation from the human body is blocked by the IR reflector 208 and the second channel 204 and thus cannot reach the detection module 206. As a result, the detection module 206 only measures the second IR radiation.

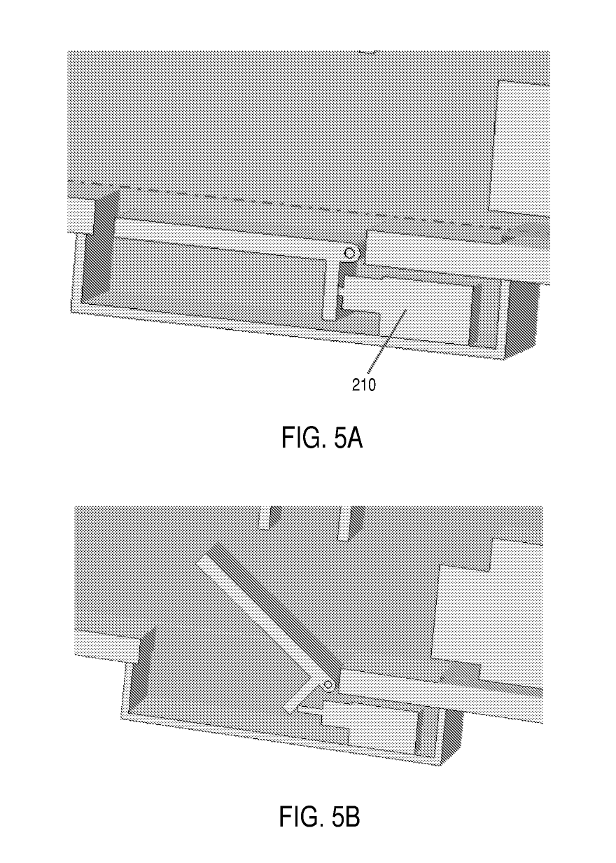

The drive module 210 is housed in a cuboid-shaped chamber defined by the bottom housing. As one example, the drive module 210 may comprise a motor for providing a rotation torque and a power transmission member for converting the rotation torque to a linear drive force for driving the IR reflector 208 (see also FIGS. 5A and 5B). As another example, the drive module 210 may comprise only a linear motor for providing a linear drive force directly to the IR reflector 208 (see also FIGS. 5A and 5B). It should be noted that the control module 212 is not shown in FIGS. 2A and 2B for the purpose of clarity. The control module 212 may be disposed within the housing at any suitable position, and may be communicatively connected with the drive module 210 and the detection module 206. It should also be noted that the terms such as “top”, “bottom”, “left”, “right”, “front”, “back” and the like are described relative to the plane of the figures. They are used merely for the purpose of convenience of description, and should not be interpreted as limiting the present disclosure.

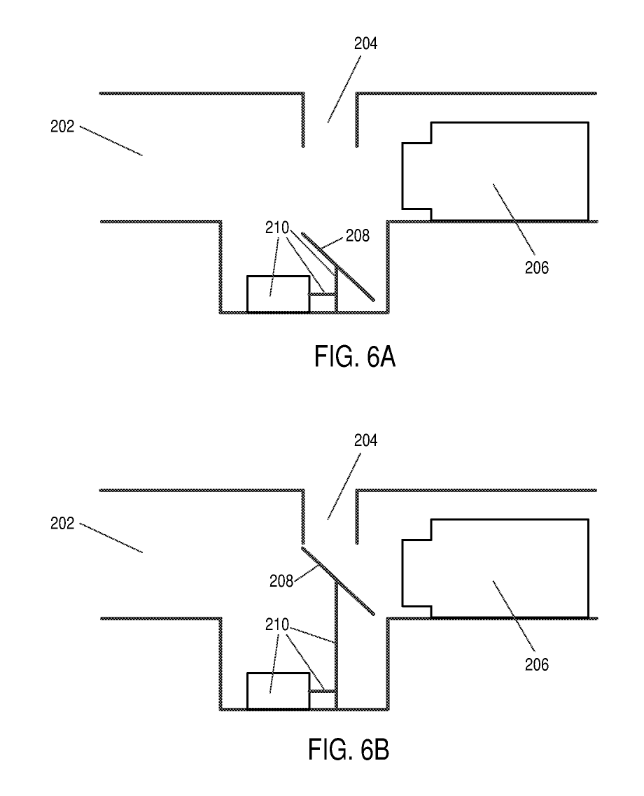

FIGS. 6A and 6B are schematic diagrams showing a thermometer in different operational states according to the second embodiment of the present disclosure. The second embodiment is similar to the first embodiment except that the IR reflector 208 of the second embodiment is not rotatable, but instead can be moved by linear displacement. In the operational state of FIG. 6A, the IR reflector 208 and the drive module 210 are housed in a chamber defined by the bottom housing. The drive module 210 may comprise for example a motor for providing a drive force, a power transmission member for transmitting the drive force, and a telescopic rod for receiving the transmitted drive force to expand or contract. The IR reflector 208 is fixed on the telescopic rod to be inclined downwards from left to right. In this operational state, the first IR radiation from a human body reaches the detection module 206 along the first channel 202, while the second IR radiation from ambient air is reflected to the right side of the chamber by the IR reflector 208 and thus cannot reach the detection module 206.

In the operational state of FIG. 6B, due to the drive force applied by the motor via the power transmission member, the telescopic rod expands upwards to move the IR reflector 208 to the second position such that the second IR radiation from the ambient air is reflected to the detection module 206, while the first IR radiation from the human body is blocked by the IR reflector 208 and the second channel 204 and thus cannot reach the detection module 206.

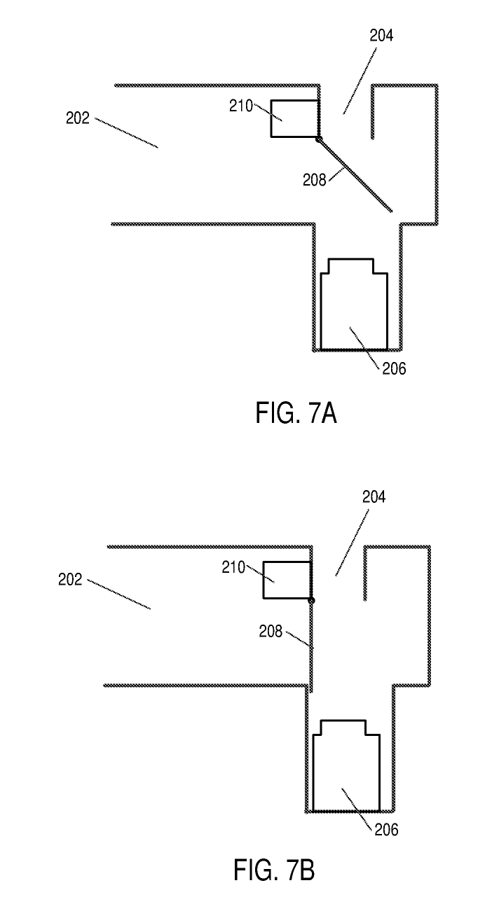

FIGS. 7A and 7B are schematic diagrams showing a thermometer in different operational states according to the third embodiment of the present disclosure. The third embodiment is similar to the first embodiment except that the first position enables the first IR radiation to reach the detection module 206 and the second position enables the second IR radiation to be reflected to the detection module 206 in the first embodiment, while the first position enables the first IR radiation to be reflected to the detection module 206 and the second position enables the second IR radiation to reach the detection module 206 in the third embodiment. As shown in FIGS. 7A and 7B, the detection module 206 is housed in a chamber defined by the bottom housing, and faces the second channel 204. The drive module 210 comprises a motor mounted at the left side of the second channel, and the IR reflector 208 is pivotally mounted via for example the output shaft of the motor. In the operational state of FIG. 7A, due to the drive force applied by the motor, the IR reflector 208 is rotated to the first position to be inclined downwards from left to right. The first IR radiation from the human body is reflected to the detection module 206, while the second IR radiation from the human body is blocked by the IR reflector 208 and thus cannot reach the detection module 206.

In the operational state of FIG. 7B, the IR reflector 208 is placed at the second position to extend vertically, thereby constituting a portion of the second channel 204. The second IR radiation from a human body reaches the detection module 206 along the second channel 204, while the first IR radiation from ambient air is reflected to the left side of the first channel 202 by the IR reflector 208 and thus cannot reach the detection module 206.

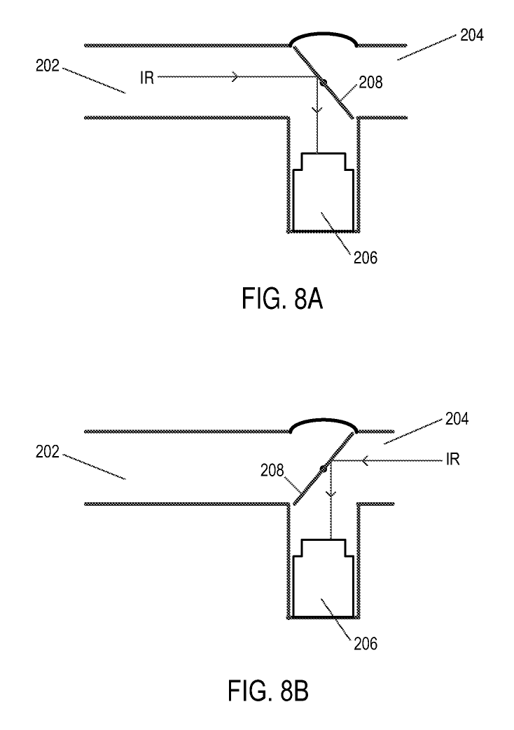

FIGS. 8A and 8B are schematic diagrams showing a thermometer in different operational states according to the fourth embodiment of the present disclosure. The fourth embodiment is similar to the third embodiment except that the second position enables the second IR radiation to reach the detection module 206 in the third embodiment, while the second position enables the second IR radiation to be reflected to the detection module 206 in the fourth embodiment. As shown in FIGS. 8A and 8B, the first channel 202 is defined by the left housing, and the second channel 204 is defined by the right housing. The IR reflector 208 is pivotally disposed between the first channel 202 and the second channel 204. The detection module 206 is housed in a chamber defined by the bottom housing, and faces the IR reflector 208. It should be noted that the drive module 210 and the control module 212 are not shown in FIGS. 8A and 8B for the purpose of clarity.

In the operational state of FIG. 8A, the IR reflector 208 is rotated to the first position to be inclined downwards from left to right. The first IR radiation from a human body is reflected to the detection module 206, while the second IR radiation from ambient air is blocked by the IR reflector 208 and thus cannot reach the detection module 206.

In the operational state of FIG. 8B, the IR reflector 208 is rotated to the second position to be inclined upwards from left to right. The second IR radiation from the ambient air is reflected to the detection module 206, while the first IR radiation from the human body is blocked by the IR reflector 208 and thus cannot reach the detection module 206.

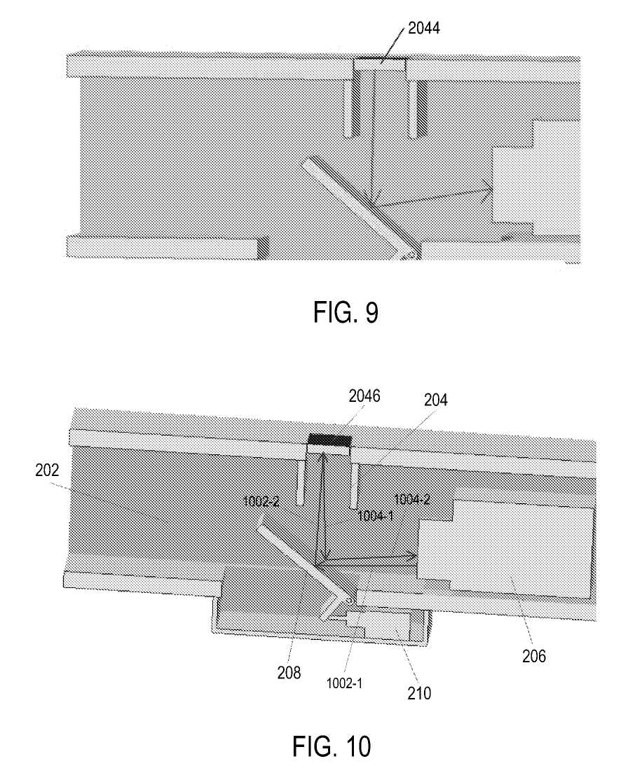

FIG. 9 is a schematic diagram showing a thermometer according to the fifth embodiment of the present disclosure. The fifth embodiment is similar to the first embodiment except that blackbody or laser radiation is used to detect ambient temperature. As shown in FIG. 9, the second channel 204 comprises an emission cover 2044 which is made of a material having a high blackbody or laser radiation generation rate and is disposed at an end facing the ambient air. Since the emission cover 2044 contacts with the ambient air, the blackbody or laser radiation emitted from the emission cover 2044 may indicate the ambient temperature. Similarly to the first embodiment, the blackbody or laser radiation may be reflected by the signal reflector 208 to the detection module 210. In this case, the detection module 210 may additionally comprise a blackbody or laser radiation sensor for measuring the blackbody or laser radiation from the emission cover. However, the present disclosure is not limited thereto. It is also possible that the human skin temperature is detected by means of blackbody or laser radiation, or both of the human skin temperature and ambient temperature are detected by means of blackbody or laser radiation.

FIG. 10 is a schematic diagram showing a thermometer according to the sixth embodiment of the present disclosure. The sixth embodiment is similar to the first embodiment except that ultrasonic wave is used to detect ambient temperature. As shown in FIG. 10, the second channel 204 comprises a reflective cover 2046 which can reflect an ultrasonic wave. The detection module 206 may additionally comprise an ultrasonic generator, an ultrasonic detector and a timer. The ultrasonic generator generates an ultrasonic wave (i.e., the second signal). The ultrasonic wave travels along the path 1002-1, then is reflected by the signal reflector 208, then travels along the path 1002-2, then is reflected by the reflective cover 2046, then travels along the path 1004-1, then is reflected by the signal reflector 208, and then travels along the path 1004-2 to reach the ultrasonic detector. The paths 1002-1 and 1002-2 may be referred to as an output passage, and the paths 1004-1 and 1004-2 may be referred to as a reflection back passage. The timer measures the travelling period from the time point at which the ultrasonic wave is generated by the ultrasonic generator to the time point at which the ultrasonic wave is detected by the ultrasonic detector. Since the speed at which an ultrasonic wave travels in the air varies according to the temperature of the air, the speed which equals to the length of the travelling paths (1002-1+1002-2+1004-1+1004-2) divided by the travelling period may indicate the temperature of the air. Thus, the measured travelling period may be the temperature-related parameter for the ambient air. In this case, the length of the travelling paths (1002-1+1002-2+1004-1+1004-2) may be measured and stored in advance in the control module 212 such that the control module 212 may calculate the speed by using the pre-stored length and the measured travelling period and determine the corresponding temperature by for example a look-up table. However, the present disclosure is not limited thereto. It is also possible that the human skin temperature is detected by means of ultrasonic wave, or both of the human skin temperature and ambient temperature are detected by means of ultrasonic wave.

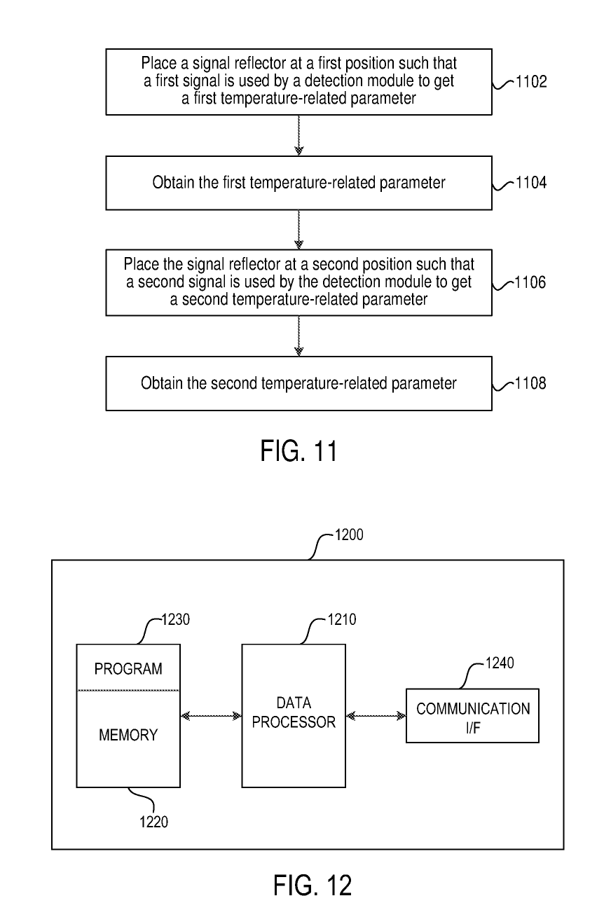

FIG. 11 depicts a flowchart of a method for temperature detection according to the principle of the present disclosure. The method may be performed by the control module of the thermometer according to the present disclosure. As shown in FIG. 11, at step 1102, the signal reflector is placed via the drive module at the first position such that the first signal which is for temperature detection of the target and guided by the first channel is used by the detection module to get the first temperature-related parameter. This step may be performed for example in response to an event that a measure button formed on the housing of the thermometer is pushed by a user. For example, the control module may send to the drive module a control signal for driving the signal reflector to a corresponding position.

At step 1104, the first temperature-related parameter is obtained from the detection module. For example, the control module may obtain a corresponding temperature-related parameter from the detection module via wired communication (e.g., a signal transmission line) or wireless communication (e.g., WiFi, Bluetooth, and the like). As mentioned above, optionally, the control module may send a detection command to the detection module to start the detection and then send a retrieval command to retrieve the detected temperature-related parameter. Alternatively, the detection module may perform the detection and send the detected temperature-related parameter to the control module at respective predetermined timings.

At step 1106, the signal reflector is placed via the drive module at the second position such that the second signal which is for temperature detection of ambient air and guided by the second channel is used by the detection module to get the second temperature-related parameter. This step may be implemented similarly to step 1102.

At step 1108, the second temperature-related parameter is obtained from the detection module. This step may be implemented similarly to step 1104.

It should be noted that step 1102 and step 1106 may also be performed in an inverted order. In this way, step 1106 may be performed for example in response to an event that a measure button is pushed by a user, and then step 1102 may be performed. For example, in the first embodiment of FIGS. 2A and 2B, the IR reflector firstly rotates upwards and the detection module gets the room temperature, and then the IR reflector rotates back and the detection module gets the skin temperature. Furthermore, step 1104 and step 1108 may be performed one after another or simultaneously, as long as step 1104 is performed after step 1102 and step 1108 is performed after step 1106.

Optionally, the method may further comprise calculating the target's inner temperature based on the first and second temperature-related parameters. Any existing algorithm may be used for this purpose.

Based on the above description, it can be seen that compared with the current solutions, the present disclosure is more suitable for instant message scene, and provide more secure and convenient methods for temperature detection. Furthermore, in a case where step 1106 and step 1102 are performed sequentially, the user may push the measure button to rotate the IR reflector just before the skin temperature test. In this way, the user can control the parameter precisely to get the room temperature just at the same time when skin temperature is measured.

FIG. 12 is a simplified block diagram showing an apparatus that is suitable for use in practicing some embodiments of the present disclosure. For example, the control module of the thermometer may be implemented through the apparatus 1200. As shown, the apparatus 1200 may include a data processor 1210, a memory 1220 that stores a program 1230, and a communication interface 1240 for communicating data with other external devices through wired and/or wireless communication.

The program 1230 is assumed to include program instructions that, when executed by the data processor 1210, enable the apparatus 1200 to operate in accordance with the embodiments of this disclosure, as discussed above. That is, the embodiments of this disclosure may be implemented at least in part by computer software executable by the data processor 1210, or by hardware, or by a combination of software and hardware.

The memory 1220 may be of any type suitable to the local technical environment and may be implemented using any suitable data storage technology, such as semiconductor based memory devices, flash memory, magnetic memory devices and systems, optical memory devices and systems, fixed memory and removable memory. The data processor 1210 may be of any type suitable to the local technical environment, and may include one or more of general purpose computers, special purpose computers, microprocessors, digital signal processors (DSPs) and processors based on multi-core processor architectures, as non-limiting examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A thermometer, comprising:
a first channel configured to guide a first signal for temperature detection of a target;
a second channel configured to guide a second signal for temperature detection of ambient air;
a detection module configured to use the first and second signals to obtain first and second temperature-related parameters respectively;
a signal reflector which is configured to reflect the first and second signals and is movable to a first position such that the first signal is used by the detection module to obtain the first temperature-related parameter, and a second position such that the second signal is used by the detection module to obtain the second temperature-related parameter;
a drive module configured to drive the signal reflector to move; and
a control module configured to place the signal reflector via the drive module at the first and second positions respectively, and obtain the first and second temperature-related parameters.

2. The thermometer according to claim 1, wherein the control module is configured to place the signal reflector at the second and first positions sequentially.

3. The thermometer according to claim 1, wherein the control module is further configured to calculate the target's inner temperature based on the first and second temperature-related parameters.

4. The thermometer according to claim 1, wherein the second channel is disposed at a different side of the thermometer than the first channel.

5. The thermometer according to claim 1, wherein a reflective surface of the signal reflector is a flat surface or a quadratic parabola surface.

6. The thermometer according to claim 1, wherein the signal reflector is rotatable to the first position to allow the first signal to reach the detection module along the first channel, and the second position to reflect the second signal to the detection module while blocking the first signal.

7. The thermometer according to claim 6, wherein when the signal reflector is placed at the first position, the signal reflector is a portion of the first channel.

8. The thermometer according to claim 6, wherein the first channel extends horizontally, the second channel is disposed on a top side of the thermometer, and the drive module is housed in a chamber at a bottom side of the thermometer.

9. The thermometer according to claim 1, wherein the signal reflector is rotatable to the first position to reflect the first signal to the detection module while blocking the second signal, and the second position to allow the second signal to reach the detection module along the second channel.

10. The thermometer according to claim 1, wherein the signal reflector is rotatable to the first position to reflect the first signal to the detection module, and the second position to reflect the second signal to the detection module.

11. The thermometer according to claim 1, wherein the first signal is an infrared radiation from the target, and the second signal is an infrared radiation from the ambient air.

12. The thermometer according to claim 11, wherein the second channel comprises a transmissive cover which is configured to allow the second signal to transmit through the transmissive cover and is disposed at an end facing the ambient air.

13. The thermometer according to claim 12, wherein the second channel further comprises a protective cover openably mounted for protecting the transmissive cover.

14. The thermometer according to claim 1, wherein at least one of the first and second channels comprises an emission cover which is made of a material having a high blackbody or laser radiation generation rate, and at least one of the first and second signals is a blackbody or laser radiation from the emission cover.

15. The thermometer according to claim 1, wherein the second channel comprises a reflective cover which is configured to reflect an ultrasonic wave, and the second signal is an ultrasonic wave which is emitted from the detection module and reflected back to the detection module via the reflective cover.

16. The thermometer according to claim 15, wherein the first signal is an ultrasonic wave which is emitted from the detection module and reflected back to the detection module via the target.

17. A method for temperature detection, comprising:
placing a signal reflector via a drive module at a first position such that a first signal which is for temperature detection of a target and guided by a first channel is used by a detection module to obtain a first temperature-related parameter;
obtaining the first temperature-related parameter;
placing the signal reflector via the drive module at a second position such that a second signal which is for temperature detection of ambient air and guided by a second channel is used by the detection module to obtain a second temperature-related parameter; and
obtaining the second temperature-related parameter.

18. The method according to claim 17, wherein the signal reflector is placed at the second and first positions sequentially.

19. The method according to claim 17, further comprising: calculating the target's inner temperature based on the first and second temperature-related parameters.

20. The method according to claim 17, wherein the second channel is disposed at a different side of a thermometer than the first channel.

21-35. (canceled)
